(19) United States
(12) Patent Application Publication
(10) Pub. No.: US 2009/0139486 A1
(43) Pub. Date: Jun. 4, 2009

(54) Gas exchange valve actuating device

(76) Inventor: Marc Oliver Wagner, Esslingen (DE)

Correspondence Address: KLAUS J. BACH, 4407 TWIN OAKS DRIVE, MURRYSVILLE, PA, 15668, US

(21) Appl. No.: 12/286,436

(22) Filed: Sep. 29, 2008

Related U.S. Application Data
(63) Continuation-in-part of application No. PCT/EP2007/002932, filed on Apr. 2, 2007.

(30) Foreign Application Priority Data
Apr. 5, 2006 (DE) 102006015893.8

(51) Int. Cl. F02D 13/04

(52) U.S. Cl. 123/321; 251/73

(57) ABSTRACT

In a gas exchange valve actuating device for transmitting a drive movement to at least one gas exchange valve of an internal combustion engine which includes a braking unit having at least one actuator, the gas exchange valve actuating device is provided with a locking unit for locking the actuator counter to an opposing force when the actuator has reached a specific position.

This is a Continuation-In-Part Application of pending International patent application PCT/EP2007/002932 filed Apr. 2, 2007 and claiming the priority of German patent application 10 2006 015 893.8 filed Apr. 5, 2006.

### BACKGROUND OF THE INVENTION

The invention relates to a gas exchange valve actuating device for transmitting an actuating movement to a gas exchange valve.

DE 693 29 064 T2 discloses a gas exchange valve actuating device for transmitting a drive movement to a gas exchange valve, in an internal combustion engine braking system which comprises a hydraulic actuator means. In order to avoid undesirably large forces, the combustion engine braking system includes an overpressure valve.

It is the principal object of the present invention to provide a gas exchange valve actuating device which is not sensitive to impulses during operation and in which nevertheless undesirably large forces can advantageously be avoided.

### SUMMARY OF THE INVENTION

In a gas exchange valve actuating device for transmitting a drive movement to at least one gas exchange valve of an internal combustion engine which includes a braking unit having at least one actuator, the gas exchange valve actuating device is provided with a locking unit for locking the actuator counter to an opposing force when the actuator has reached a specific position.

Before the locking occurs by means of the locking unit, adjustment of the actuator can be permitted and it is possible to avoid a situation in which the actuator moves out completely just before a top dead center of an internal combustion engine piston and undesirably large forces occur owing to high cylinder pressures. In addition, when the actuator means is locked, undesired distribution of the actuator means when impulses occur can reliably be avoided with the result that, in particular even at high rotational speeds, an advantageous braking effect can be achieved. “Provided” is to be understood here in particular as meaning specially equipped and/or configured.

If the actuator means is formed by an actuator piston which can be actuated hydraulically and/or if the locking unit is of hydraulic design, the latter can be configured in a way which is particularly structurally simple and also cost-effective considering the large forces which generally occur. The term “locking unit of hydraulic design” is to be understood to mean in particular a unit which utilizes hydraulic fluid for locking purposes.

Various means, which appear appropriate to a person skilled in the art, are conceivable for limiting, to a desired degree, the forces which occur before the locking process, said means being, for example, a pressure-limiting valve or, particularly advantageously, at least one bypass via which pressure medium can flow up to the specific position of the actuator means, as a result of which undesirably large forces can be avoided in a structurally simple way and the locking unit can be implemented in a structurally simple way. In particular, by means of a corresponding refinement it is possible to avoid pressure limiting valves which have to be configured particularly precisely, and to avoid the costs which such valves entail.

If at least one pressure-limiting valve is arranged in the bypass, losses via the bypass can advantageously at least be reduced.

In a particular embodiment of the invention, the bypass is arranged at least partially in the actuator means, as a result of which the latter can be integrated in a particularly space-saving fashion.

Preferably, the gas exchange valve actuating device has at least one energy storage unit which is provided for storing energy during a compensating movement of the actuator. With an appropriate configuration it is possible to permit the actuator to move out over a plurality of working cycles, in particular over more than 720° of a crankshaft, and it is also possible overall to permit particularly rapid moving-out of the actuator after a first compensating movement. An overall activation time of the internal combustion engine braking unit can be reduced.

The energy storage unit is preferably formed by a hydraulic pressure accumulator, which can be provided in a structurally simple way, in particular if the actuator is formed by an actuator piston which can be actuated hydraulically and/or the locking unit is a hydraulic device. The term “hydraulic pressure accumulator unit” is to be understood to mean in this context in particular a storage unit in which hydraulic pressure medium can be stored, in particular under pressure.

If the energy storage unit has at least one mechanical spring element, the energy storage unit can be configured in a structurally simple and flexible way.

Arranging the spring element at least partially inside the actuator can save installation space.

The invention will become more readily apparent from the following description of exemplary embodiments of the invention on the basis of the accompanying drawings.

### BRIEF DESCRIPTION OF THE DRAWINGS

FIG. 1 shows integral parts of a gas exchange valve actuating device,

FIG. 2 shows an actuator unit of an internal combustion engine braking unit of the gas exchange valve actuating device in the deactivated position,

FIG. 3 shows the actuator unit of FIG. 2 with the actuator partially extended,

FIG. 4 shows the actuator unit of FIG. 2 with the actuator extended slightly further than in FIG. 3,

FIG. 5 shows an alternative actuator unit with a bypass which is partially integrated in an actuator,

FIG. 6 shows an alternative actuator unit with an energy storage structure,

FIG. 7 shows an alternative actuator unit with an energy storage structure which is integrated in the actuator, and

FIG. 8 shows another alternative actuator unit with an energy storage structure which is integrated in an actuator.

### DESCRIPTION OF VARIOUS EMBODIMENTS

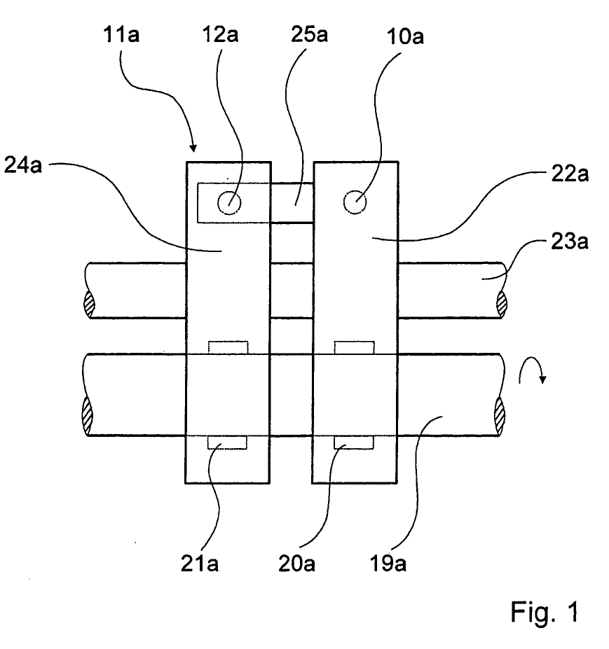

FIG. 1 shows individual parts of a gas exchange valve actuating device of an internal combustion engine which is provided for transmitting a drive movement to gas exchange valves 10a, with just one gas exchange valve 10a being indicated. The gas exchange valve actuating device comprises a camshaft 19a with an outlet valve actuating cam 20a and a brake cam 21a of an internal combustion engine braking valve unit 11a. The outlet valve actuating cam 20a acts on a first end of an outlet rocker lever 22a which is pivotally mounted on a rocker lever support shaft 23a and acts with its second end on the gas exchange valve 10a which is for example an outlet valve.

The brake valve actuator cam 21a is arranged on the camshaft 19a in the region of a brake rocker lever 24a of the internal combustion engine braking unit 11a. The brake rocker lever 24a is likewise mounted so as to be pivotable on a rocker lever shaft 23a so that it is be pivotable relative to the brake rocker lever 24a outside a braking operation.

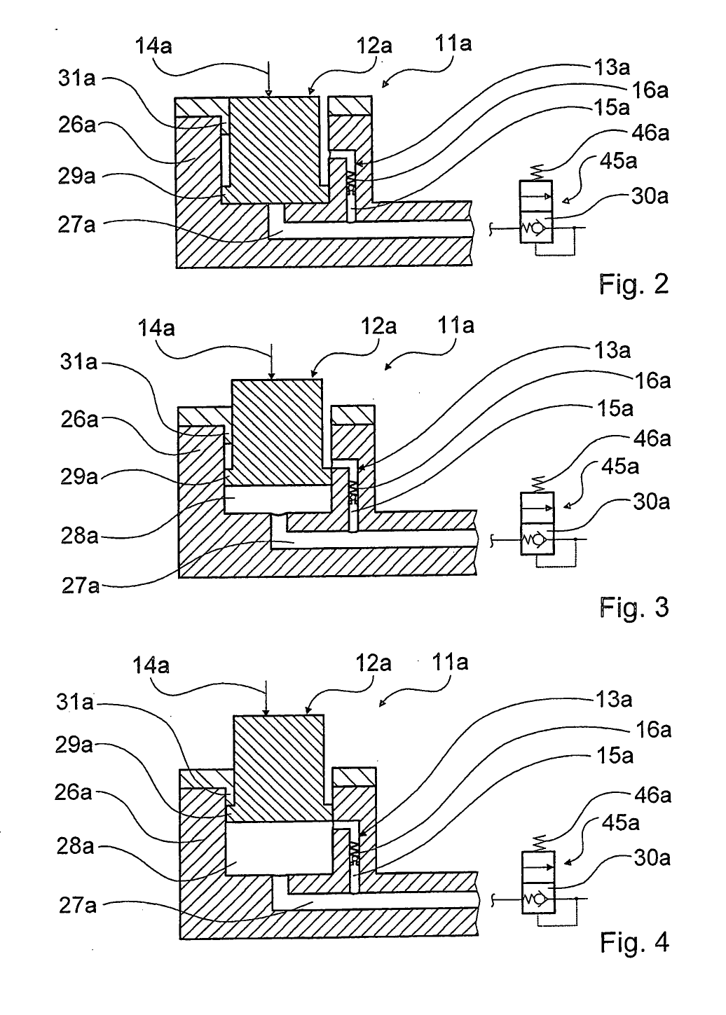

The brake rocker lever 24a has, at its end facing the gas exchange valve 10a, a transverse arm 25a which extends under the brake rocker lever 24a transversely with respect to the brake rocker lever 24a or parallel with respect to the rocker lever support shaft 23a in the direction of toward the outlet valve rocker lever 22a. An actuator unit with an actuator means 12a which is formed by an actuator piston which can be actuated hydraulically is arranged between the transverse arm 25a and the brake rocker lever 24a (FIGS. 1 and 2). The actuator 12a is guided in a housing 26a of the actuator unit.

According to the invention, the actuator unit has a hydraulic locking unit 13a, which is provided for locking the actuator 12a counter to an opposing force 14a starting from a specific position of the actuator means 12a. The locking unit 13a has a bypass 15a which is formed by a duct which is provided in the housing 26a, via which a bypass 15a pressure medium can be discharged up to the specific position of the actuator 12a.

Before the braking operation is initiated, the actuator 12a is in its lower position as a result of the force of gravity acting on the actuator means 12a or due to the force of a spring (not illustrated). The gas exchange valve 10a is opened by the outlet valve cam 20a via the outlet rocker lever 22a independently of the brake cam 21a, and is closed by means of a valve spring (not illustrated in more detail) which acts in the closing direction on the gas exchange valve 10a.

When the braking operation is activated, a 2/2 way valve 45a is switched by means of a build up in pressure and pressure medium flows via a non-return valve 30a of the 2/2 way valve 45a and via an inflow duct 27a into a pressure chamber 28a underneath the actuator 12a, so that the actuator 12a moves out of the housing 26a (FIG. 3).

If the rocker levers 22a, 24a are coupled via the actuating unit before the actuator 12a moves fully out, so that a force which is brought about by the brake cam 21a acts on the actuator unit via the brake rocker lever 24a and, as a result, an opposing force 14a acts on the actuator 12a, pressure medium can be discharged from the pressure space 28a via the inflow duct 27a and via the bypass 15a with the result that the actuator 12a can carry out a compensating movement in the direction of the opposing force 14a, which avoids undesirably large forces on the gas exchange valve actuating device. In order to avoid undesirable losses when the actuator 12a moves out before the rocker levers 22a, 24a are coupled via the bypass 15a, a pressure-limiting valve 16a is arranged in the bypass 15a. The pressure-limiting valve 16a is closed without an opposing force or without a significant opposing force when the actuator 12a moves out, and said pressure-limiting valve 16a opens when the actuator 12a moves out at a pressure slightly above a maximum system pressure in the inflow duct 27a of the internal combustion engine, or when the rocker levers 22a, 24a are coupled during the moving-out of the actuator 12a. It is, however, basically also conceivable for a bypass to be provided without a corresponding pressure-limiting valve 16a.

If the actuator 12a moves out completely before the rocker levers 22a, 24a are coupled via the actuator unit and a force which is generated by the brake cam 21a acts on the actuator unit via the brake rocker lever 24a and as a result the opposing force 14a acts on the actuator means 12a, the actuator 12a is locked by the locking unit 13a, specifically by virtue of the fact that the bypass 15a is in communication at on both ends with the pressure space 28a or the bypass 15a connects the pressure space 28a to the inflow duct 27a, and is prevented by virtue of the fact that pressure medium can be discharged via the bypass 15a (FIG. 4). In the completely moved out state, the actuator means 12a comes to bear with its guide collar 29a against a stop 31a.

If an opening force which is generated by the brake cam 21a acts on the actuator unit via the brake rocker lever 24a, the non-return valve 30a closes and the opening force can be transmitted to the outlet tilting lever 22a via the actuator unit and the transverse arm 25a, and to the gas exchange valve 10a via the outlet rocker lever 22a, and the gas exchange valve 10a can be opened at crankshaft angles which are predefined by the brake cam 21a.

If the braking operation is deactivated, the pressure upstream of the 2/2 way valve 45a drops and the 2/2 way valve 45a is switched back into its starting position, driven by a spring force of a spring element 46a, with the result that the pressure medium can be discharged from the pressure space 28a via the inflow duct 27a and via the 2/2 way valve 45a.

The inflow duct 27a and the bypass 15a are dimensioned in such a way that at any pressure medium temperature or oil temperature which will possibly occur during operation and given any rotational speed of the internal combustion engine which will possibly occur during operation, the actuator 12a can move out completely in one working cycle, reduced by an opening time of the gas exchange valve 10a.

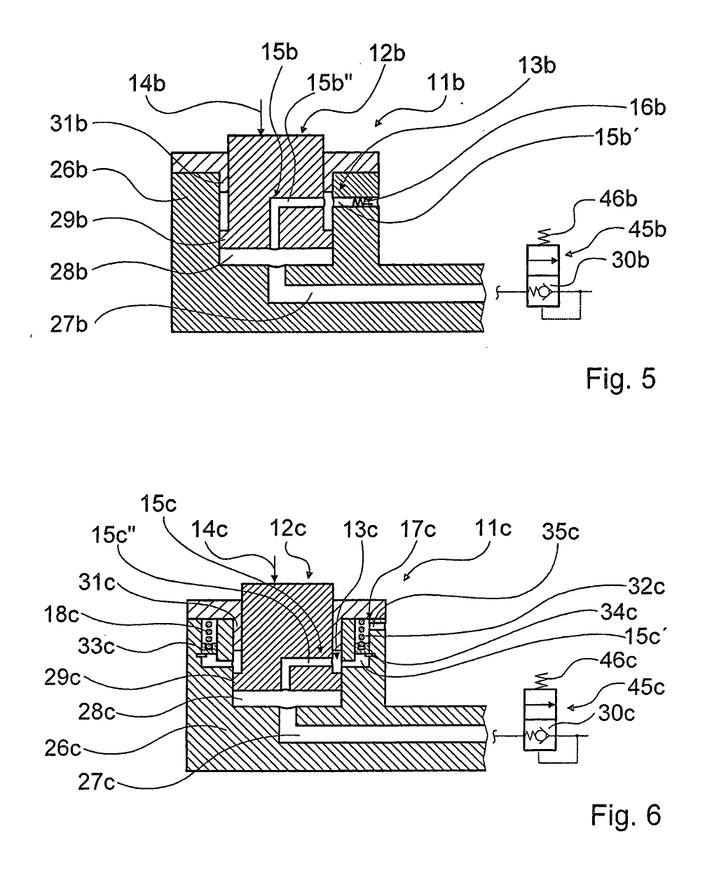

FIGS. 5 to 8 illustrate alternative exemplary embodiments. Components, features and functions which remain essentially the same are provided with the same reference signs. However, in order to differentiate the exemplary embodiments, the letters a to e are added to the reference numerals of the exemplary embodiments. The following description is limited essentially to the differences from the exemplary embodiment shown in FIGS. 1 to 4, in which case reference can be made to the description of the exemplary embodiment shown in FIGS. 1 to 4 for components, features and functions which remain the same.

FIG. 5 illustrates an alternative actuator unit with a locking unit 13b which has a bypass 15b which is partially arranged within an actuator 12b. Before the actuator 12b moves out completely, pressure medium can be discharged from a pressure space 28b via the bypass 15b. If the actuator 12b moves out completely, a duct section 15b′ of the bypass 15b in a housing 26b of the actuator unit is closed off from the outside by a guide collar 29b of the actuator 12b, and a duct section 15b″ of the bypass 15b is closed off from the outside by a stop 31b, and the actuator 12b is locked.

FIG. 6 illustrates an alternative actuator unit with a locking unit 13c which has a bypass 15c which is arranged partially in an actuator 12c. In addition, the actuator unit has an energy storage unit 17c which is formed by a hydraulic pressure storage unit and which is provided for storing energy during a compensating movement of the actuator 12c. The energy storage unit 17c has, in an annular space 32c of a housing 26c of the actuator unit, a mechanical spring element 18c which is formed by a coil compression spring and is supported at a first end on a component which forms a stop 31c, and at a second end, on a spring disk 33c. The spring disk 33c is secured by a spring washer 34c in the direction facing away from the spring element 18c and the spring disk 33c is guided so as to be displaceable in the annular space 32c in the direction of the spring element 18c counter to a spring force of the spring element 18c. In this context, an abutment at the stop 31c prevents the spring element 18c from being compressed to the full extent.

Before the braking operation is activated, the actuator 12c is in its lower position owing to the force of gravity acting on the actuator means 12c or due to the force of a spring (not illustrated).

When the braking operation is initiated, pressure medium flows via an inflow duct 27c into a pressure space 28c underneath the actuator 12c, and the actuator 12c moves out of the housing 26c (FIG. 6).

If rocker levers which correspond to the exemplary embodiment in FIGS. 1 to 4 are coupled via the actuator unit before the actuator 12c moves out virtually completely with the result that a force which is brought about by a brake cam acts on the actuator unit via a brake rocker lever and as a result an opposing force 14c acts on the actuator 12c, pressure medium can flow out of the pressure space 28c via the bypass 15c and into the annular space 32c which forms a pressure medium space. In this context, the spring disk 33c is displaced counter to the spring force of the spring element 18c, and the actuator 12c carries out a compensating movement in the direction of action of the opposing force 14c, as a result of which undesirably large forces are avoided. If the opposing force 14c is eliminated again, the spring element 18c relaxes and forces the pressure medium out of the annular space 32c and back into the pressure space 28c, as a result of which the actuator 12c moves out particularly quickly again to its position at which it was located before the coupling of the rocker levers. The actuator 12c can be extended further up to the next time the rocker levers are coupled. A kind of iterative moving-out of the actuator means 12c, in particular even over several working cycles, can be achieved.

When the actuator 12c moves out completely, the actuator 12c is locked by means of the locking unit 13c, specifically by closing a duct section 15c′ of the bypass 15c by means of a guide collar 29c of the actuator 12c and a duct section 15c″ of the bypass 15c by means of the stop 31c, with the result that pressure medium is prevented from being discharged from the pressure space 28c via the bypass 15c and into the annular space 32c. In order to avoid a build up of pressure in the region of the spring element 18c due to leakage, the annular space 32c is connected via a duct 35c to a space which adjoins the actuator unit.

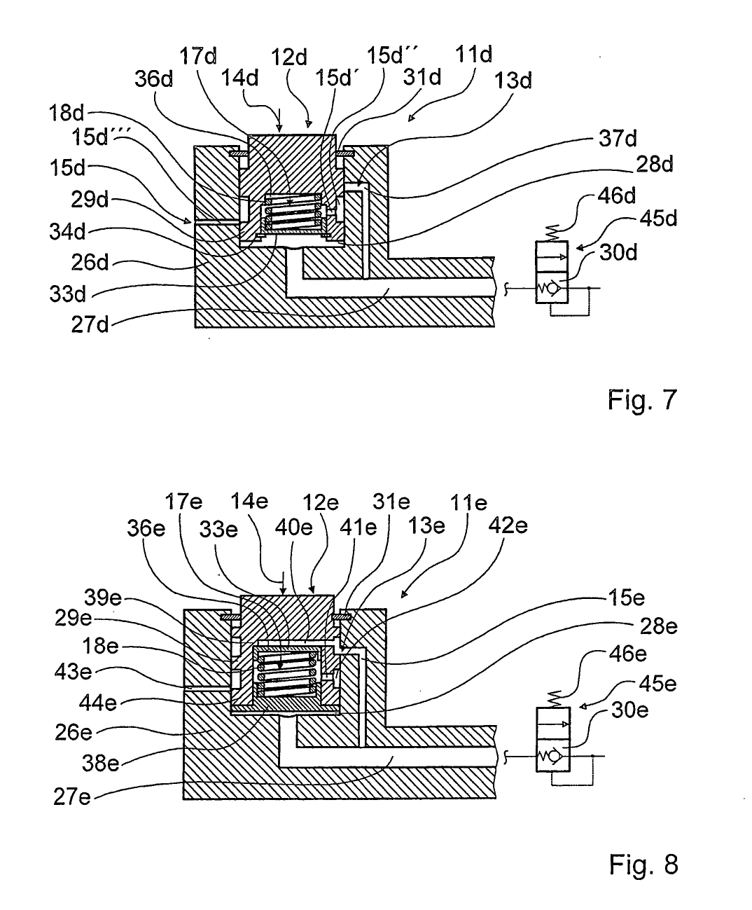

FIG. 7 illustrates an alternative actuator unit with a locking unit 13d which has a bypass 15d which is partially arranged in an actuator 12d. In addition, the actuator unit has an energy storage unit 17d which is formed by a hydraulic pressure storage unit and which is provided for storing energy during a compensating movement of the actuator 12d. The energy storage unit 17d has, within the actuator 12d in a spring space 36d, a mechanical spring element 18d which is formed by a coil compression spring and is supported at a first end on an underside of the actuator and at a second end on a spring disk 33d. The spring disk 33d is secured in the actuator 12d in the direction facing away from the spring element 18d by a spring ring 34d and is guided in the actuator means 12d in such a way that it can be displaced in the direction of the spring element 18d, counter to a spring force of the spring element 18d. In this context, a stop (not illustrated in more detail) in the actuator 12d pre-vents the spring element 18d from being compressed to the full extent.

Before the braking operation is initiated, the actuator 12d is in its lower position owing to the force of gravity acting on the actuator 12d or due to the force of a spring (not illustrated).

When the braking operation is initiated, pressure medium flows via an inflow duct 27d into a pressure space 28d underneath the actuator 12d and/or underneath the spring disk 33d, and the actuator means 12d moves out of the housing 26d (FIG. 7).

When the rocker levers which correspond to the exemplary embodiment shown in FIGS. 1 to 4 are coupled via the actuator unit before the actuator 12d has moved out virtually completely, with the result that a force which is brought about by a brake cam acts on the actuator unit via a brake rocker lever and as a result an opposing force 14d acts on the actuator 12d, the spring element 18d is compressed and pressure medium can be discharged from the spring space 36d via the bypass 15d, specifically via a duct section 15d′ in the actuator 12d, an annular space 15d″ between the actuator means 12d and the housing 26d and via a duct section 15d′″ in the housing 26d. In the process, the spring plate 33d is displaced counter to the spring force of the spring element 18d, and the actuator 12d carries out a compensating movement in the direction of action of the opposing force 14d, as a result of which undesirably large forces are avoided. If the opposing force 14d is eliminated again, the spring element 18d relaxes and the actuator 12d is pushed back to its position at which it was located before the coupling of the rocker levers. In this context it is also possible in particular to suck in air via the bypass 15d. The actuator 12d can be moved out further up to the next time the tilting levers are coupled.

When the actuator 12d is completely moved out, the actuator means 12d is locked by means of the locking unit 13d, specifically by virtue of the fact that the bypass 15d and/or the duct section 15d′″ is/are closed by a guide collar 29d of the actuator 12d, with the result that pressure medium is prevented from being discharged from the spring space 36d via the bypass 15d. In addition, when the actuator means 12d is completely moved out, the spring space 36d is connected via a duct 37d to the inflow duct 27d with the result that remaining air is forced out of the spring space 36d during operation by a pumping effect, the spring space 36d is completely filled with hydraulic pressure medium from the inflow duct 27d, and the actuator means 12d can be locked by means of the hydraulic pressure medium.

FIG. 8 illustrates an alternative actuator unit with a locking unit 13e which has a bypass 15e. In addition, the actuator unit has an energy storage unit 17e which is formed by a hydraulic pressure storage unit and which is provided for storing energy during a compensating movement of an actuator 12e. The energy storage unit 17e has, in a spring space 36e inside the actuator 12e, a mechanical spring element 18e which is formed by a coil compression spring and which is supported, at a first end facing a supporting face of the actuator 12e for a tilting lever, on a spring disk 33e which is mounted in the actuator 12e, and at a second end on a lid 38e which is attached in the actuator 12e. The spring disk 33e is secured by a shoulder 39e of the actuator 12e in the direction facing away from the spring element 18e and is guided so as to be displaceable in the actuator 12e in the direction of the spring element 18e, counter to a spring force of the spring element 18e. In this context, a stop (not illustrated in more detail) in the lid 38e pre-vents the spring element 18e from being compressed to the full extent.

Before the braking operation is initiated, the actuator 12e is in its lower position owing to the force of gravity acting on the actuator 12e or due to the force of a spring (not illustrated).

When the braking operation is initiated, pressure medium flows via an inflow duct 27e into a pressure space 28e underneath the actuator 12e and/or underneath the lid 38e, and the actuator 12e moves out of a housing 26e (FIG. 8).

When the rocker levers which correspond to the exemplary embodiment in FIGS. 1 to 4 are coupled via the actuator unit before the actuator 12e has moved out virtually completely, with the result that a force which is brought about by a brake cam acts on the actuator unit via a brake rocker lever and as a result an opposing force 14e acts on the actuator 12e, the spring element 18e is compressed, and pressure medium can flow from the pressure space 28e into a pressure space 40e in the actuator 12e via the inflow duct 27e and via the bypass 15e. In this context, the spring disk 33e is pushed counter to the spring force of the spring element 18e, and the actuator 12e carries out a compensating movement in the direction of action of the opposing force 14e, as a result of which undesirably large forces are avoided. If the opposing force 14e is eliminated again, the spring element 18e relaxes, the pressure medium is pushed out of the pressure space 14e via the bypass 15e and via the inflow duct 27e into the pressure space 28e, and the actuator 12e is pushed back to its position at which it was located before the coupling of the tilting levers. The actuator 12e can be moved out further up to the next time the tilting levers are coupled. In order to avoid a build up of pressure in the spring space 36e due to leakage, the spring space 36e is connected via a duct 41e, an annular space 42e and via a duct 43e to a space which adjoins the actuator unit.

When the actuator 12e is completely moved out, the actuator 12e is locked by means of the locking unit 13e, specifically by virtue of the fact that the bypass 15e is closed by means of a guide collar 29e of the actuator 12e, with the result that pressure medium is prevented from being discharged from the pressure space 28e into the pressure space 40e in the actuator 12e via the bypass 15e. In addition, the duct 43e is closed by means of a guide collar 44e of the actuator 12e.

What is claimed is:

1. A gas exchange valve actuating device for transmitting a drive movement of an actuator to at least one gas exchange valve (10a) of an internal combustion engine including an internal combustion engine braking unit (11a; 11b; 11c; 11d; 11e) having at least one actuator means (12a; 12b; 12c; 12d; 12e), said gas exchange valve actuating device comprising a locking unit (13a; 13b, 13c; 13d; 13e) for locking the actuator (12a; 12b; 12c; 12d; 12e) counter to an opposing force (14a; 14b; 14c; 14d; 14e) when the actuator (12a; 12b; 12c; 12d; 12e) has reached a specific position.

2. The gas exchange valve actuating device as claimed in claim 1, wherein the actuator (12a; 12b; 12c; 12d; 12e) comprises an actuator piston which can be actuated hydraulically.

3. The gas exchange valve actuating device as claimed in claim 1, wherein the locking unit (13a; 13b, 13c; 13d; 13e) is a hydraulic unit operated by a hydraulic pressure medium.

4. The gas exchange valve actuating device as claimed in claim 3, wherein the locking unit (13a; 13b, 13c; 13d; 13e) includes at least one bypass (15a; 15b; 15c; 15d; 15e) which is open until the actuator (12a) reaches the specific position.

5. The gas exchange valve actuating device as claimed in claim 4, wherein at least one pressure-limiting valve (16a; 16b) is arranged in the bypass (15a; 15b).

6. The gas exchange valve actuating device as claimed in claim 4, wherein the bypass (15b; 15c; 15d) is provided at least partially in the actuator (12b; 12c; 12d).

7. The gas exchange valve actuating device as claimed in claim 1, wherein at least one energy storage unit (17c; 17d; 17e) is provided for storing energy during a compensating movement of the actuator (12c; 12d; 12e).

8. The gas exchange valve actuating device as claimed in claim 7, wherein the energy storage unit (17c; 17d; 17e) is formed by a hydraulic pressure accumulator unit.

9. The gas exchange valve actuating device as claimed in claim 7, wherein the energy storage unit (17c; 17d; 17e) includes a mechanical spring element (18c; 18d; 18e).

10. The gas exchange valve actuating device as claimed in claim 9, wherein the mechanical spring element (18d; 18e) is arranged at least partially inside the actuator (12d; 12e).
